(19) United States
(12) Patent Application Publication
(10) Pub. No.: US 2012/0022851 A1
(43) Pub. Date: Jan. 26, 2012

(54) ON-DEMAND TRANSLATION OF APPLICATION TEXT

(75) Inventors: Richard Bremner, Sydney (AU); William J. Izard, Sydney (AU); Matthew J. Ponsford, Sydney (AU); Glenn W. Rush, Marrickville (AU)

(73) Assignee: INTERNATIONAL BUSINESS MACHINES CORPORATION, Armonk, NY (US)

(21) Appl. No.: 12/842,211

(22) Filed: Jul. 23, 2010

(51) Int. Cl. G06F 17/28

(52) U.S. Cl. 704/3

(57) ABSTRACT

Embodiments of the present invention provide a method, system and computer program product for on-demand translation of text. In an embodiment of the invention, a method for on-demand translation of text can include receiving in a dynamic translation module executing in memory by at least one processor of a host computer, a message request from an executing application for text in a language for a target locale. The method further can include retrieving text in a language for a locale different from the target locale and translating the retrieved text into a language for the target locale. Finally, the method can include returning the translated retrieved text to the application.

### BACKGROUND OF THE INVENTION

1. Field of the Invention

The present invention relates to locale management for a computer program and more particularly to locale management of text for a computer program.

2. Description of the Related Art

Locale management refers to presentation of textual content of a computer program in a language native to a specified locale. It is possible to create a computer program that is hard coded to present textual information in a specific language. To deploy the computer program in multiple different locales, the textual content must be replaced and the computer program rebuilt for each of the different locales. Addressing the globalization of the information technology market space, many properly architected computer programs separate much of the textual content from the source code of the computer program. Consequently, the textual content, incorporated in a “resource”, can be duplicated into different languages and only a resource for a desired locale can be included with the source code during build time.

A resource bundle is a file that contains locale-specific data. In the particular circumstance of the Java programming language, a resource bundle is a properties file containing locale-specific data. As in the case of the generic resource, the use of a resource bundle provides a way to internationalize an application by making the code locale-independent. As it is well-known in the art, resource bundles are essentially text files and the most common type of text in a resource bundle is a list of strings. Each string has a “key” to identify the string, which is the same in all of the different resource bundles. Thus, when writing code for the application, only the key need be mentioned as opposed to the corresponding string resulting in locale-independent code.

In this regard, human translation must be applied to a resource bundle in advance of the shipping of the application. Translation may not be available prior to distribution, or may be prohibitively expensive or time consuming, further inhibiting the testing of an application prior to deployment. Translation may not be available for minor product updates due to the cost involved. Mock translation in which the character set and directionality of a language for a locale is provided, but not an actual translation, often is used to facilitate testing of an application prior to full translation and deployment. Regardless, there is little substitute for an actual translation into a target locale of an application, particularly during the test phase of the application prior to deployment.

In this regard, machine translation can be used to algorithmically parse a document of text in one language, translating each word into a different language. Of course, machine translation is available only for a limited set of languages and must be applied to a resource bundle in advance of the building of the application. Machine translation is may not be available prior to distribution, further inhibiting the testing of an application prior to deployment. Mock translation in which the character set and directionality of a language for a locale is provided, but not an actual translation, often is used to facilitate testing of an application prior to full translation and deployment. Regardless, there is little substitute for an actual translation into a target locale of an application, particularly during the test phase of the application prior to deployment.

### BRIEF SUMMARY OF THE INVENTION

Embodiments of the present invention address deficiencies of the art in respect to localization of a computer program and provide a novel and non-obvious method, system and computer program product for on-demand translation of text. In an embodiment of the invention, a method for on-demand translation of text can include receiving in a dynamic translation module executing in memory by at least one processor of a host computer, a message request from an executing application for text in a language for a target locale. The method further can include retrieving text in a language for a locale different from the target locale and translating the retrieved text into a language for the target locale. Finally, the method can include returning the translated retrieved text to the application.

In one aspect of the embodiment, retrieving text in a language for a locale different from the target locale can include first identifying a resource bundle for the locale different from the target locale and querying the identified resource bundle with the message request. Thereafter, in response to the querying, text can be received corresponding to the message request in a language for the locale different from the target locale. In another aspect of the embodiment, translating the retrieved text into a language for the target locale can include transmitting a request to translate the retrieved text into the language for the target locale to a machine translation service over a computer communications network and receiving from the machine translation service from over the computer communications network in response to the transmitting, translated text in a language for the target locale. Finally, in yet another aspect of the embodiment, a resource bundle can be identified for the target locale, the identified resource bundle can be queried with the message request and, in response to the querying, text can be received that corresponds to the message request in a language for the target locale. Consequently, the received text can be returned to the application without first requiring translation.

In another embodiment of the invention, a data processing system can be configured for on-demand translation of text. The system can include a host computer with at least one processor and memory and an application server executing in the memory of the host computer. The system further can include a data store of resource bundles, each corresponding to a different locale. Even further, an application in the application server can utilize the resource bundles. Finally, a dynamic translation module can be coupled to the application. The module can include program code enabled to receive a message request from the application for text in a language for a target locale, to retrieve text in a language for a locale different from the target locale from a resource bundle amongst the resource bundles, to translate the retrieved text into a language for the target locale, and to return the translated retrieved text to the application. Optionally, a machine translation service can be coupled to the host computer over a computer communications network and configured to translate the retrieved text into the language for the target locale.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for on-demand translation of text in a resource bundle;

FIG. 2 is a schematic illustration of a data processing system configured for on-demand translation of text in a resource bundle; and,

FIG. 3 is a flow chart illustrating a process for on-demand translation of text in a resource bundle.

### DETAILED DESCRIPTION OF THE INVENTION

Embodiments of the invention provide for a method, system and computer program product for on-demand translation of text. In accordance with an embodiment of the invention pertaining to the use of resource bundles for localization of an application, a request to retrieve text for a target locale by way of a request key can be received. In response to the receipt of the request, it can be determined whether or not a resource bundle for the target locale is available, or if the resource bundle for the target locale is available but the requested key is not present in the resource bundle. If so, the requested text can be retrieved from the resource bundle for the target locale and returned to the requestor. Otherwise, a resource bundle for a locale already available can be selected and text corresponding to the request can be retrieved from the already available locale. Subsequently, the retrieved text can be submitted to a machine translation service over a computer communications network such as the global Internet in order to translate the retrieved text into a language consistent with the target locale. Finally, the translated text once provided by the machine translation service can be returned to the requestor. In this way, text in the application can be translated at least in part if not in full despite the non-existence of the required resource bundle for the target locale, or the absence from the required resource bundle of a request key.

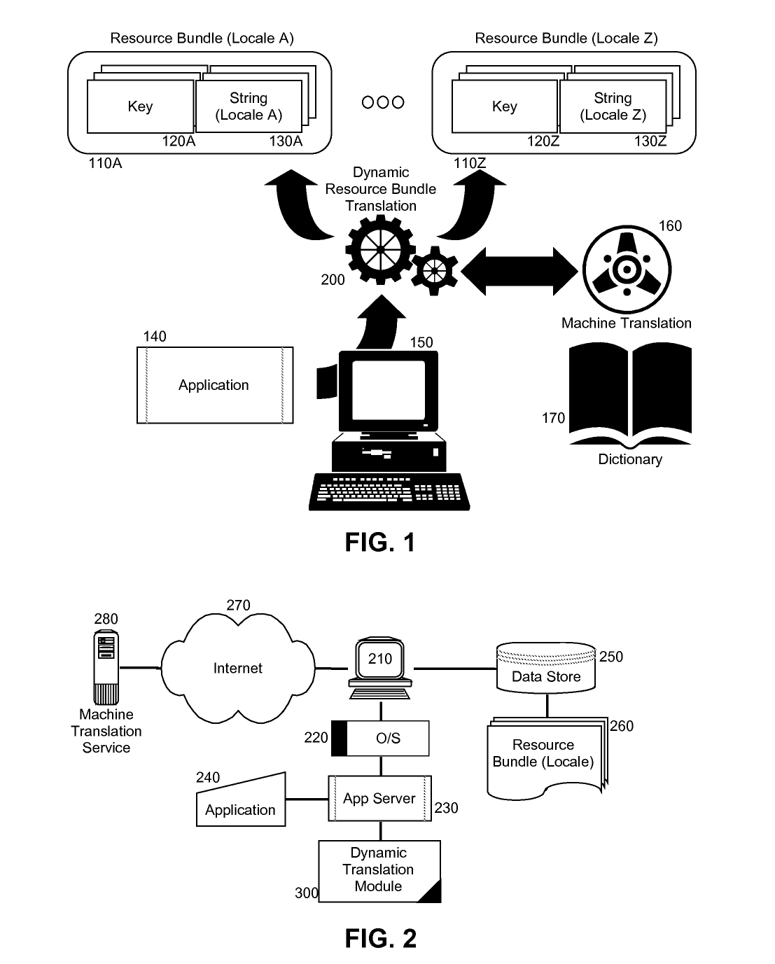

In further illustration, FIG. 1 pictorially shows a process for on-demand translation of text in a resource bundle. As shown in FIG. 1, a computer 150 can host application 140 executing in memory by at least one processor of the computer 150. The application 140 can incorporate multiple different resource bundles 110A, 110Z providing variable localization of the application 140. In one aspect of the embodiment, each of the resource bundles 110A, 110Z can include a set of key value pairs such that a provided key (for instance in the form of a message) 120A, 120Z can produce a resulting value—namely text 130A, 130Z of a language consistent for a locale of a corresponding one of the resource bundles 110A, 110Z.

Of note, dynamic resource bundle translation data processing system 200 can manage requests for localized text resulting from the application 140. In this regard, the system 200 can receive a request for localized text in a target locale in the form of a message with a request key from the application 140. The system 200 in turn can determine if one of the resource bundles 110A, 110Z already exists for the target locale. If so, the message can be passed to the one of the resource bundles 110A, 110Z already existing for the target locale and text corresponding to the message in language of the target locale can be returned from the one of the resource bundles 110A, 110Z to the system 200 and on to the application 140.

In contrast, if the system 200 cannot locate a resource bundle amongst the resource bundles 110A, 110Z for the target locale, or if the resource bundle for the target locale is available but the requested key is not present in the resource bundle, the message can be passed to a pre-determined one of the resource bundles 110A, 110Z in order to retrieve corresponding text in a locale other than the target locale and the retrieved corresponding text can be submitted to machine translation service 160. The machine translation service 160 in turn can translate with dictionary 170 the retrieved corresponding text into a language for the target locale and returned to the system 200. Finally, the system 200 can return the translated text to the application 140. Notably, as an option, the translated text can be cached in memory in association with a request key and target locale. Consequently, subsequent requests for localized text reflected by the request key in the target locale can be satisfied from the cache without requiring an additional machine translation.

The process described in FIG. 1 can be implemented in a data processing system. By way of example, FIG. 2 is a schematic illustration of a data processing system configured for on-demand translation of text in a resource bundle. The system can include a host computer 210 with memory and at least one processor. The host computer 210 can include an operating system 220 hosting the execution of an application server 230 supporting the execution of an application 240. The application 240 can be configured for variable localization through the use of different resource bundles 260 stored in data store 250 for different target locales.

Of note, dynamic translation module 300 can be coupled to the application server 230. The dynamic translation module 300 can include program code that when executed by the host computer 210 can receive messages from the application 240 for text strings in a language of a target locale. The program code further when executed by the host computer 210 can either return a requested text string in a language of the target locale by way of a resource bundle 260 for the target locale, or retrieve a requested text string in a language of a different locale by way of a resource bundle 260 for the different locale, and obtain a dynamic translation into a language of the target locale of the retrieved text string from machine translation service 280 over computer communications network 270, such as the global Internet.

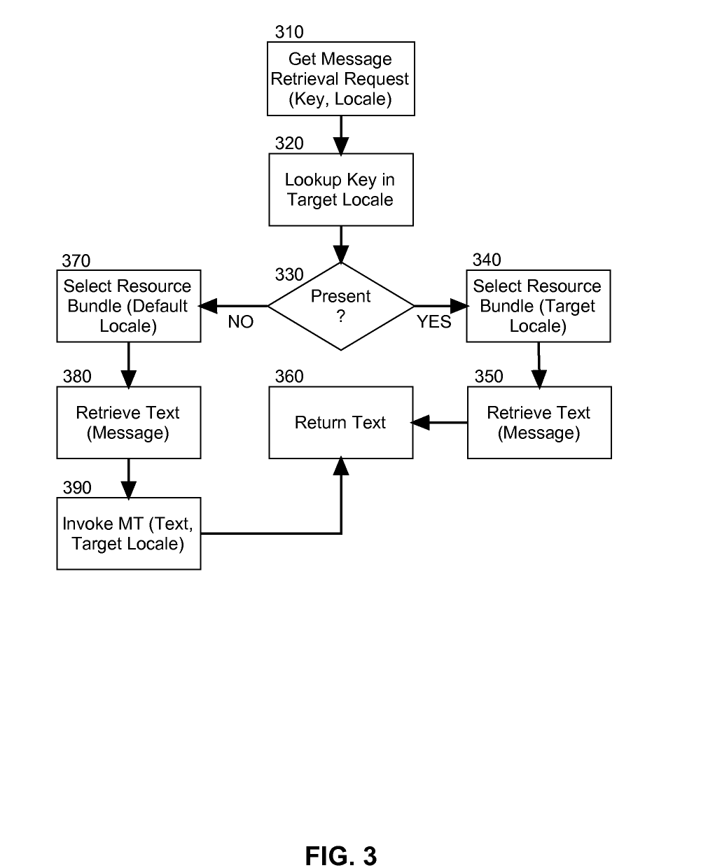

In even yet further illustration of the operation of the dynamic translation module 300, FIG. 3 is a flow chart illustrating a process for on-demand translation of text in a resource bundle. Beginning in block 310, a text retrieval request can be received in reference to a message for a target locale. In block 320, existing resource bundles can be inspected and in decision block 330, it can be determined whether or not a resource bundle exists for the target locale. If so, in block 340 the existing resource bundle for the target locale can be queried with the message to obtain resulting text in a language for the target locale in block 350. Finally, in block 360 the resulting text can be returned to the requestor.

In decision block 330, if it is determined that a resource bundle amongst the resource bundles does not exist for the target locale, in block 370 a resource bundle for a different locale than the target locale can be selected and queried with the message to obtain resulting text in a language for the different locale in block 380. Thereafter, in block 390 the resulting text can be passed to a machine translation service to obtain a translation of the resulting text into a language for the target locale. Finally, in block 360 the translated text can be returned to the requestor.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for on-demand translation of text comprising:
receiving in a dynamic translation module executing in memory by at least one processor of a host computer, a message request from an executing application for text in a language for a target locale;
retrieving text in a language for a locale different from the target locale;
translating the retrieved text into a language for the target locale; and,
returning the translated retrieved text to the application.

2. The method of claim 1, wherein retrieving text in a language for a locale different from the target locale, comprises:
identifying a resource bundle for the locale different from the target locale;
querying the identified resource bundle with the message request; and,
receiving in response to the querying, text corresponding to the message request in a language for the locale different from the target locale.

3. The method of claim 1, wherein translating the retrieved text into a language for the target locale, comprises:
transmitting a request to translate the retrieved text into the language for the target locale to a machine translation service over a computer communications network; and,
receiving from the machine translation service from over the computer communications network in response to the transmitting, translated text in a language for the target locale.

4. The method of claim 1, further comprising:
identifying a resource bundle for the target locale;
querying the identified resource bundle with the message request;
receiving in response to the querying, text corresponding to the message request in a language for the target locale; and,
returning the received text to the application without requiring translation.

5. The method of claim 1, further comprising caching the translated retrieved text for retrieval in response to a subsequent message request from an executing application for text in the language for the target locale.

6. A data processing system configured for on-demand translation of text comprising:
a host computer with at least one processor and memory;
an application server executing in the memory of the host computer;
a data store of resource bundles, each of the resource bundles corresponding to a different locale;
an application in the application server utilizing the resource bundles; and,
a dynamic translation module coupled to the application, the module comprising program code enabled to receive a message request from the application for text in a language for a target locale, to retrieve text in a language for a locale different from the target locale from a resource bundle amongst the resource bundles, to translate the retrieved text into a language for the target locale, and to return the translated retrieved text to the application.

7. The system of claim 6, further comprising a machine translation service coupled to the host computer over a computer communications network and configured to translate the retrieved text into the language for the target locale.

8. A computer program product for on-demand translation of text, the computer program product comprising:
a computer readable storage medium having computer readable program code embodied therewith, the computer readable program code comprising:
computer readable program code for receiving a message request from an executing application for text in a language for a target locale;
computer readable program code for retrieving text in a language for a locale different from the target locale;
computer readable program code for translating the retrieved text into a language for the target locale; and,
computer readable program code for returning the translated retrieved text to the application.

9. The computer program product of claim 8, wherein the computer readable program code for retrieving text in a language for a locale different from the target locale, comprises:
computer readable program code for identifying a resource bundle for the locale different from the target locale;
computer readable program code for querying the identified resource bundle with the message request; and,
computer readable program code for receiving in response to the querying, text corresponding to the message request in a language for the locale different from the target locale.

10. The computer program product of claim 8, wherein the computer readable program code for translating the retrieved text into a language for the target locale, comprises:
computer readable program code for transmitting a request to translate the retrieved text into the language for the target locale to a machine translation service over a computer communications network; and,
computer readable program code for receiving from the machine translation service from over the computer communications network in response to the transmitting, translated text in a language for the target locale.

11. The computer program product of claim 8, further comprising:
computer readable program code for identifying a resource bundle for the target locale;
computer readable program code for querying the identified resource bundle with the message request;
computer readable program code for receiving in response to the querying, text corresponding to the message request in a language for the target locale; and,
computer readable program code for returning the received text to the application without requiring translation.

12. The computer program product of claim 11, further comprising computer readable program code for caching the translated retrieved text for retrieval in response to a subsequent message request from an executing application for text in the language for the target locale.
